(19) United States
(12) Patent Application Publication
(10) Pub. No.: US 2004/0208577 A1
(43) Pub. Date: Oct. 21, 2004

(54) Methods for in-service wavelength upgrade and system performance optimization in WDM optical networks

(75) Inventor: Michael John Laurence Cahill, Boston, MA (US)

Correspondence Address: LAHIVE & COCKFIELD, LLP., 28 STATE STREET, BOSTON, MA, 02109, US

(73) Assignee: Sycamore Networks, Inc., Chelmsford, MA (US)

(21) Appl. No.: 10/202,197

(22) Filed: Jul. 23, 2002

(51) Int. Cl. H04B 10/08; H04J 14/02

(52) U.S. Cl. 398/83

(57) ABSTRACT

A method of adding wavelengths to an “in-service” WDM optical network system carrying live traffic. The method divides the wavelength into groups and adds each group of wavelengths into the working system in a parallel way by determining the desired TX launch power change for each wavelength from a predetermined value and applying the power changes for the group all together. When the system performance degradation happens after wavelengths addition, a wavelength power balance method according to another aspect of this invention can be applied to optimize the system performance. The power balance method first identifies the wavelengths to be optimized and classifies the wavelengths into controllable and reserved wavelengths; the total power available for wavelength adjustment is then determined; for each controllable wavelength, the required TX launch power which will bring the wavelength to meet the desired performance is determined and applied.

### FIELD OF THE INVENTION

The present invention relates generally to optical networks, and more particularly, to wavelength division multiplexing (WDM) system performance optimization and in-service wavelength upgrade.

### BACKGROUND OF THE INVENTION

Optical communication systems facilitate data exchange between users by sending optical pulses that encode data through optical fibers. Data streams in the electrical domain are modulated and encoded into optical pulses that are received and decoded back into an electrical data stream for the recipient. The optical pulses travel through optical fibers that can carry one or more channels. Wavelength division multiplexing (WDM) systems are those that transmit a plurality of channels in a single fiber. Each of the channels corresponds to a predetermined wavelength.

In dense wavelength division multiplexing (DWDM) networks, multiple optical signals (each operating at a different wavelength) are multiplexed onto a signal fiber. Each wavelength corresponds to a channel, and the optical performance of the channel is defined in terms of its optical power and optical signal-to-noise ratio (OSNR). These performance parameters directly affect the channel's electrical performance, which may be expressed in terms of its bit error rate (BER) and system Q. Optical performance inconsistencies from channel to channel can result from a variety of factors, including non-uniform optical amplifier gain and noise, wavelength-dependent fiber loss and fiber non-linearity, such as stimulated Raman scattering (SRS). The achievable capacity of a fiber-optic communication system thus can be severely limited by variations in optical performance across the channel wavelengths.

In optical communication systems, optical power is an important parameter used in determining the overall system performance. Typically, the system monitors total optical power and power per channel. The total power can be detected by photodetectors in a fiber amplifier card (FAC) for controlling fiber amplifiers, such as erbium-doped fiber amplifiers (EDFAs) and Raman amplifiers (RAs). The power per channel can be measured by optical performance monitors (OPMs) and may be used for balancing and optimizing channel performance. OPMs can also be used to measure the OSNR of each channel. Per channel power adjustments are made to achieve flat gains and/or equal optical signal to noise ratios (OSNR) across channels. The channel power adjustments can be used to tune the transmitters (TX) to maintain desired optical OSNR and/or optical power at the receivers (RX) for the channels over the bandwidth.

Channel performance disparities are compensated for to attempt to equalize channel performance in a DWDM system. The optical power of each DWDM wavelength launched at the transmitter can be selectively varied and the optimum system performance can be obtained. This approach is referred to as WDM Power Emphasis or power balancing.

Previous techniques for power emphasis measure the total power launched into an Optical System Under Test (OSUT). The total power is divided among all wavelengths according to a weighting function determined by each wavelength's optical performance at the end of the system. These techniques assume that OSUT can be treated as a purely linear device. They are easy to implement, can converge quickly to a reasonable solution, but they become less accurate as the number of FACs and/or wavelengths increase. This type of methods is possibly the most common procedure used to emphasis WDM wavelengths.

Common to each of the existing approaches is the use of a narrow definition for “system optimization”, i.e. these approaches are used to achieve one specific type of system performance, e.g. constant received optical signal-to-noise ratio (OSNR). These approaches are primarily useful in optimizing the performance of optical systems assuming the wavelengths have the same TX and RX nodes, and pass through an OSUT that does not have any wavelength-selective optical filtering. They were not designed to optimize systems with more realistic architectures such as having optical add/drop modules (OADMs).

An alternative method of system optimization involves the use of BERs to determine the optical balancing required to optimize the system. This technique uses the measurement of each channel's BER to determine the required changes in per-channel optical power that will make each channel's BER equal. Since a BER measurement includes all the effects of all transmission impairments (including nonlinear effects, not just those relating to optical power and OSNR), altering the optical power will not provide the required changes in BER performance under all typical circumstances. This technique attempts to optimize a multi-variable problem by changing one variable, but such a simple optimization process does not provide a global solution. Furthermore, the process is unable to provide the user with information relating to the way in which the optimization cannot be achieved, since no variables are individually modified. Some potential problems that can undermine this optimization process include sub-optimal TX-RX electrical characteristics, multi-path interference in the optical transmission, and fibre non-linearity. Each of these impairments may result in a system that is degraded and balanced to a worst-case channel.

None of the techniques discussed above adequately deal with system capacity upgrade, where additional wavelengths need to be inserted into the system. Customers demand non-traffic affecting capacity upgrades and if, for any reason, the system performance is degraded due to the upgrades, system performance will have to be optimized to a predefined wavelength performance requirement.

It would, therefore, be desirable to provide in a DWDM system a method of “in service” wavelength upgrading and automatic system performance optimization based on optical power balancing. This method must be able to support a variety of optical architectures that are realized in practical optical networks.

It would, therefore, also desirable to provide optical system or subsystem a fast and accurate way of power balancing which will optimize user-defined system performance.

### SUMMARY OF THE INVENTION

The present invention provides methods and procedures for “in service” wavelength insertion/upgrading and automatic system performance optimization. With the proposed methods and procedures, multiple wavelengths can be inserted into a system when the system is “in service” due to customer requirements, such as a capacity upgrade, and overall system performance can be enhanced by equalizing WDM channel performance, such as per channel power (TX and RX), and RX OSNR.

In one aspect of the invention, a parallel approach for multiple wavelength addition is proposed. This approach does not require communication among nodes. A network node where the wavelengths will be added are identified and the wavelengths to be added is divided into multiple groups, where each group has one or more wavelengths. Each group of wavelengths is inserted into system. For each wavelength in a group, the TX launch power is set to a predetermined value. In addition, a power change that will bring the wavelength power up to the desired TX launch power is determined, and the power change is applied to the wavelength, while monitoring the optical performance of existing wavelengths at the TX and RX if required. The wavelength addition technique then works in conjunction with the power balancing technique to optimize the existing and added wavelengths.

In another aspect of the invention, the wavelengths to be optimized via power balancing are first identified and classified into controllable and reserved wavelengths For each controllable wavelength, the required TX power change that will result in the predetermined performance is determined. The required TX launch power which will bring the wavelength to meet the desired performance metric is then determined and applied.

### BRIEF DESCRIPTION OF THE DRAWINGS

The invention will be more fully understood from the following detailed description taken in conjunction with the accompanying drawings, in which:

FIG. 1 is a block diagram of a DWDM transmission system indicating power and OSNR measurement locations in accordance with an illustrative embodiment of the present invention.

FIG. 2 shows an exemplary implementation of power and OSNR measurement in a node for add/drop wavelengths using two FACs, or the mid-stage of a dual-stage FAC.

FIG. 3 is a flow diagram illustrating the operation of the multiple wavelengths addition method of the illustrative embodiment.

FIG. 4 is a flow diagram illustrating the operation of the power balance method of the illustrative embodiment.

FIG. 5A is a flow diagram illustrating the steps performed during initialization.

FIG. 5B is a flow diagram illustrating the steps performed to identify optical traces and determine controllable and reserved wavelengths.

FIG. 5C is a flow diagram illustrating the steps performed to find and set wavelengths that do not require power balancing.

FIG. 5D is a flow diagram illustrating the steps performed to find and set wavelengths that require power balancing

FIG. 5E is a flow diagram illustrating the steps performed to check the TX or RX maximum power emphasis (MPE).

FIG. 5F is a flow diagram illustrating the steps performed to apply the power adjustment.

### DETAILED DESCRIPTION OF THE INVENTION

Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

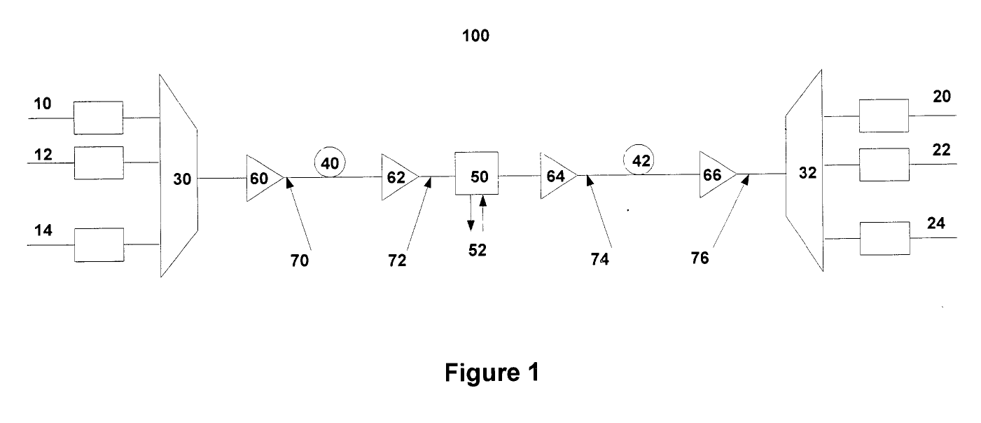

FIG. 1 illustrates elements of an optical network in a DWDM system (100) that is suitable for practicing the illustrative embodiment of the present invention. The multiple channel transmitter signals (10), (12), and (14) are combined by a TX multiplexer (30) onto one fiber (40) that carries all of the channels. Alternatively, a dynamic gain filter (DGF) may be used in place of a bank of optical transmitters connected to a multiplexer. Optical amplifiers (60), (62), (64) and (66) assure that a signal of adequate power is transmitted over the spans and that adequate power and OSNR are delivered to RX demultiplexer (32). Channels are dropped and added by an OADM (50). The use of amplifiers (62) and (64) before and after the OADM (Optical add/drop module) compensate for OADM loss. Once the signal is received by the DGF or demultiplexer (32), the signal is broken into its component channels, which are then delivered to the respective receivers, (20), (22) and (24).

The amplifiers (60), (62), (64) and (66), used in the DWDM system amplify the multiplexed optical signals, but also inject noise into the signal across the wavelength spectrum. Therefore, some locations (70), (72), (74) and (76) in the DWDM system are monitored using OPMs coupled, via an optical tap, to the optical fiber, as is known in the art. The output of the amplifier 60 can be monitored at location 70 to determine the optical power of each wavelength launched into the transmission span. The OADM amplifier 64 output can also be monitored at location 74 to determine the optical power of added wavelengths. The output of the RX amplifier 66 can be monitored at location 76 in order to determine the received optical power and OSNR of each wavelength, and the amplifier output at the input to the OADM (62) can be monitored at location 72 for the same reason. These monitoring locations provide information for the wavelength addition and power balancing procedures, which is required to perform their respective operations while ensuring negligible optical impact on the optical transmission system.

The illustrative embodiment of the present invention provides a method of adding wavelengths at the TX and/or OADMs to an “in-service” WDM optical network system carrying live traffic. The method divides the wavelength into groups and adds each group of wavelengths into the working system in a parallel way by determining the desired TX launch power change for each wavelength from a predetermined value and applying the power changes for the group all together. The proposed method does not require knowledge of all TX and RX wavelength's locations, it measures the performance degradation of existing wavelengths as they pass through the node where the wavelengths will be added, and the overall power degradation at the system level is inferred so it does not require the inter-node communication. However, if RX information is available, it can be used to more accurately calculate the system level degradation without inference. When system performance degradation arises, a wavelength power balance method according to another aspect of this invention can be applied to optimize the system performance. The power balance method first identifies the wavelengths to be optimized and classifies the wavelengths into controllable and reserved wavelengths. The total power available for wavelength adjustment is then determined. For each controllable wavelength, the required TX power change that will result in the nominal TX launch power and corresponding RX power and OSNR is determined In addition, the required TX launch power which will bring the wavelength to meet the desired performance is determined and applied.

When adding or adjusting a wavelength to an existing system, measurements of optical power and optical spectrum shape are required at the transmitter and possibly receiver nodes in order to ensure acceptable wavelength performance. The invention is applicable to networks equipped with performance monitoring capabilities such as in the system (100). More precisely, the methods of the invention are applicable to WDM transmission systems, which are in general provided with means for measuring total optical power and per channel power and/or OSNR at various network locations of interest, such as locations (70), (72), (74), (76) in the system (100).

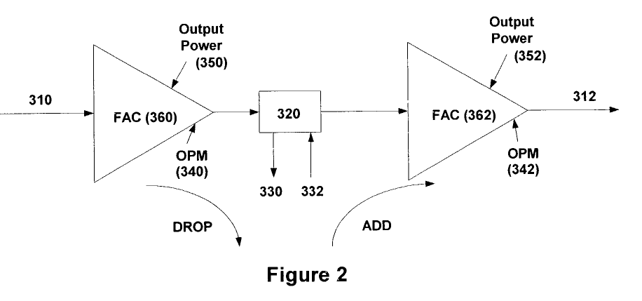

FIG. 2 shows an exemplary implementation of a node in a DWDM optical communication system with wavelength add/drop and power and OSNR measurements capability in accordance with the illustrative embodiment of the present invention. As is shown in FIG. 2, the optical signal (310) is amplified by first FAC (or first stage of a dual stage FAC) (360) before some channels (330) are dropped and some channels (332) are added at add/drop multiplexer (320). The signal then goes through the second FAC (or second stage of a dual stage FAC) (362), resulting in amplified output signal (312). For the illustrative implementation, the RX location for the dropped wavelengths is the output of the first FAC (360), i.e. output power meter (350) and output OPM port (340), and the TX location of the added wavelengths is the second FAC (362), i.e. output power meter (352) and output OPM port (342).

“In Service” Multiple Wavelength Upgrade

Increasing the system capacity through addition of wavelengths requires a sophisticated procedure that turns-on the additional wavelengths to an acceptable performance level, while ensuring that the existing wavelengths' performance is not degraded. The procedure described below adds wavelengths at a particular node using a parallel approach, that saves time relative to the serial approach. This approach does not require knowledge of all TX (transmitter) and RX (receiver) wavelengths' locations. This approach measures the performance degradation of existing wavelengths as they pass through the node of interest while wavelengths are being added, and the overall power degradation at the system output is inferred. This approach significantly simplifies the turn-up process since no communication between nodes is required. However, if inter-node communication is available, and the power and OSNR performance of all wavelengths is available, this information can be used to directly determine the performance degradation of existing wavelengths during the wave addition, without inference.

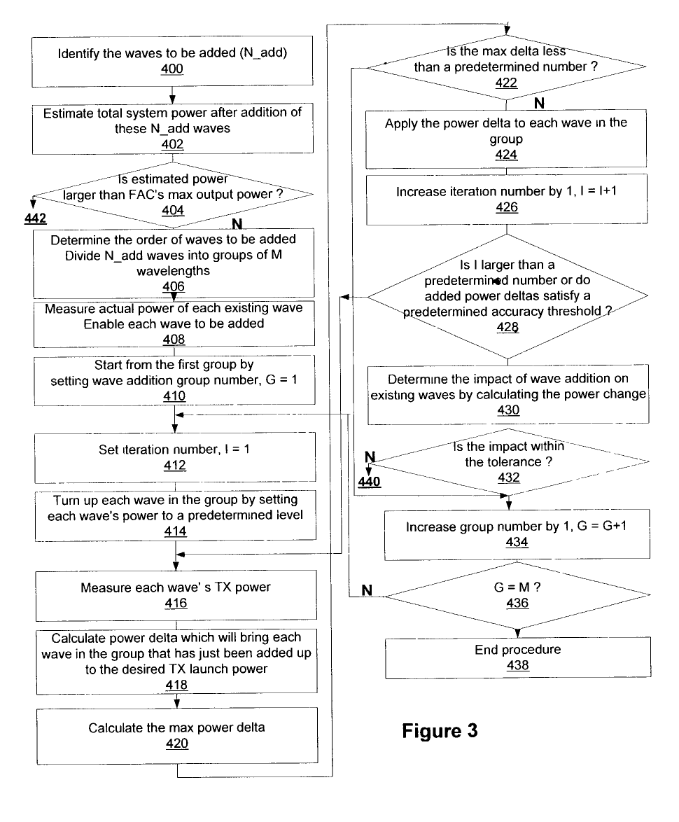

For transmitter TX or a particular node such as shown in FIG. 2, where the wavelengths will be added, the operations of the in-service wavelength addition procedure are illustrated in FIG. 3. First, the system is initialized. The initialization includes identifying the number of the wavelengths (N_{add}) to be added (400). If the wavelengths to be added are located in different transmission bands, such as the C band and the L band, the proposed method should be applied on each wavelength band separately. Nevertheless, both bands are monitored (for possible wavelength degradation) during the procedure. The TX FAC and TX OPM locations of the wavelengths to be added are identified depending on the add/drop node configuration (as illustrated in FIG. 2), among many possible add/drop node implementations.

The nominal output power per wavelength out of the amplifier, P_{TX wave nom FAC} (dBm), as well as the amplifier maximum output power, P_{TX total max FAC} (dBm) are provided by the FAC Turn-up MIB (Management Information Base) for illustrated embodiment in FIG. 2. The procedure ensures that N_{add} wavelengths will be launched near to the nominal power level; therefore the total system power after addition of these N_{add} wavelengths, P_{TX total est FAC}, can be estimated (402) by adding the estimated TX launch power of the added wavelengths to the output power of the amplifier before the addition (all power units in decibel-milliwatts):

$$\begin{matrix}{P}_{TX total est FAC} = \begin{matrix}total initial power + \\ estimated power of added wavelengths\end{matrix} \\ = \begin{matrix}10 * {log}_{10} [ a {log}_{10} ( 0.1 * {P}_{TX total init FAC} ) + \\ {N}_{add} * a {log}_{10} ( 0.1 * {P}_{TX wave norm FAC} ) ] \end{matrix}\end{matrix}$$

The estimated total amplifier power is compared with the FAC's maximum output power as defined in calibration (404). If the estimated total amplifier power P_{TX total est FAC} is larger than the FAC's maximum output power (404), the procedure suggests that some of the existing wavelengths should be reduced in power before the proposed method can be applied (442). Otherwise, it begins the wavelength addition procedure.

The order of wavelength addition is determined by dividing the wavelengths into groups of M wavelengths (406), where M defines the maximum number of wavelengths that can be added in parallel, and is a predetermined number, such as M=20. The grouping of wavelengths can be done in many different ways, one way of doing it is based on ITU grid standard wavelength. Before addition of wavelengths, the wavelengths to be added are checked to see if they collide with existing wavelength traffic at TX location by making sure that existing wavelengths are different from wavelengths to be added.

The desired TX launch power of each added wave, P_{TX add wave i des FAC}, can be determined at this point. There are a variety of ways of determining P_{TX} add wave_{i des FAC}, one way is set it to the adjacent wave's power (the adjacent wave may be an existing or added wave whose desired power has already been set), P_{TX adj wave i FAC}, so that the added wave's power closely reflects the typical power of existing wavelengths. However, if the added wave is more than, say 1 nm, away from the adjacent wave, the desired power of added wave can be further set to the nominal TX launch power.

```
If|λ_{add wave i} − λ_{adj wave} | < 1 then
    P_{TX add wave i des FAC} = P_{TX adj wave i FAC}
Else
    P_{TX add wave i des FAC} = P_{TX wave nom FAC}
```

Next, the actual wavelength power P_{TX exist wave i, init, FAC} is obtained by measuring the optical spectra using the TX OPM of all existing wavelengths launched out of the node's FAC into the fiber span (and if possible, each RX wavelength power, P_{RX exist wave i init FAC} via measurement at all RX nodes). This information is used to determine if any power degradation of existing wavelengths has occurred during the wavelength addition. For each wavelength to be added, the output power is set at the output of each wavelength port, P_{TX wave i PORT}, to a predetermined value such as the minimum design value (e.g. −15 dBm), and a check of the OPM is performed to ensure that the wavelength is present at the FAC output, to thereby determine each wavelength's TX power into the transmission fiber, P_{TX add wave i FAC} (408). This step allows up to M wavelengths to turn-on and lock in parallel and therefore save significant amounts of time over a linear approach, where wavelengths are added one at a time.

The procedure then starts the group wavelength addition process. Starting from the first group of up to M wavelengths to be added (410), the required power change Δ_{TX wave i} (dB) is calculated for each wavelength that has just been added. The required power change will bring each wavelength up to the desired TX launch power is calculated as (418):

Δ_{TX wave i}=P_{TX add wave i des FAC}−P_{TX add wave i FAC}

The largest change magnitude, Δ_{TX wave max} (dB) is calculated (420) as the absolute maximum value of all the individual required power changes of added wavelengths, Δ_{TX wave i}. If Δ_{TX wave max} is smaller than a predetermined value, such as 0.5 dB, there is no need for power adjustment for this group of wavelengths, so the process proceeds to step 434 for the next group of wavelengths. Otherwise, each Δ_{TX wave i} is applied to each wavelength by altering the output power of each wavelength's port by Δ_{TX wave i} (424). The process may be repeated (426) by going back to step (416) for the same group of wavelengths to ensure accuracy of the added wavelengths' powers. An upper limit in terms of number of iterations (such as 5) can be employed (428).

The performance of the existing wavelengths after the group wavelength addition can be determined by measuring the optical power of each wavelength at the FAC output, P_{TX exist wave i, FAC}, to ensure the existing wavelengths performance will not be degraded too much due to additional wavelength insertion. The impact the additional wavelengths have on the existing wavelengths can be determined by calculating the change in the FAC (TX) power of all existing wavelengths, relative to the “initial optical performance”, i.e. each wavelength's performance before any wavelengths were added (430) as:

ΔP_{TX exist wave i FAC}=P_{TX exist wave i FAC}−P_{TX exist wave i init FAC}

If the optical performance information is also available from each receiver node in the link, then also compare the existing waves' optical performance (power and OSNR) before and after the wave addition:

ΔP_{RX exist wave i FAC}=P_{RX exist wave i FAC}−P_{RX exist wave i init FAC}

ΔO_{RX exist wave, i}=O_{RX exist wave i}−O_{RX exist wave i init}

One way of checking to see if the impact of wavelength addition on existing wavelengths is within an acceptable tolerance is to compare the absolute value of the largest ΔP_{TX exist wave max FAC} (and ΔP_{RX exist wave i FAC}, ΔO_{RX exist wave i} if available) with a predetermined value, such as 2 dB. If the Δ with the largest magnitude is less than the predetermined value (432), the existing wavelengths are within acceptable tolerance limits, and more wavelengths can be added by processing the next group of wavelengths (434, 436). Otherwise, the existing wavelengths are defined as out of tolerance and the system performance optimization via multiple wavelength balancing, another aspect of the invention has to be employed before additional wavelengths can be added (440).

Multiple Wavelength Power Balancing

Optimizing the performance of all wavelengths in a WDM system becomes increasingly complex as the wavelength count increases. Extra complexity is added when different optical network architectures need to be supported, such as an add/drop architecture. Therefore, a system optimization method and procedure that addresses the needs of multiple wavelengths is needed. One of ordinary skill in the art will additionally appreciate different ways to alter the parameters of the embodiments disclosed, such as including add/drop wavelengths, in a manner still in keeping with the spirit and scope of the present invention. The relationship between change of TX power and change of RX power and OSNR can be modeled in different ways, such as linear models versus nonlinear models, and static models versus dynamic models. For illustrative purposes, in the following, the proposed procedure assumes a first-order linear approximation to estimate RX powers and OSNRs when the TX Powers are altered. Iteration of the procedure is employed to improve its accuracy. This method requires knowledge of the locations for TX and RX wavelength monitoring (of power and spectrum). The average power of all wavelengths to be balanced is set to a predetermined value such as the nominal TX launch power.

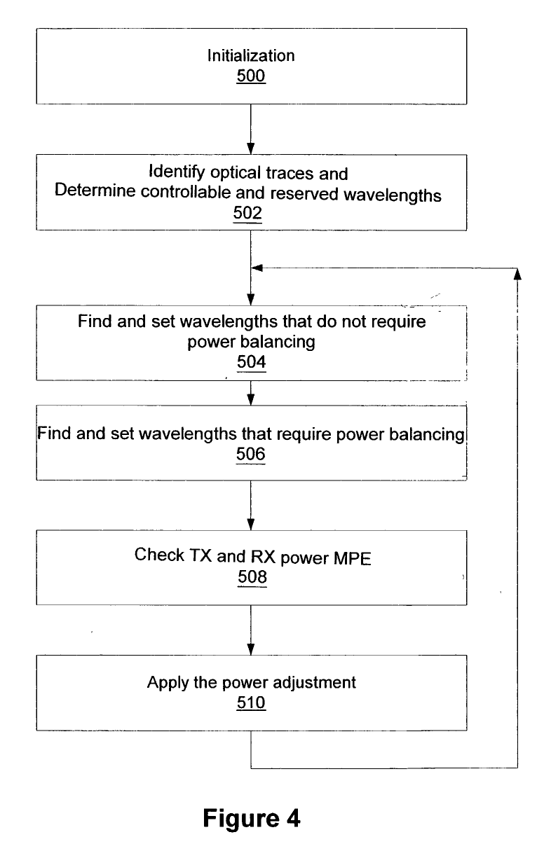

One embodiment of the wavelength power balance method is illustrated in FIG. 4. The system is first initialized (500). The optical traces are then identified while controllable and reserved wavelengths are also determined (502). The proposed power balance method is implemented as a multiple iteration process. The first iteration focuses on the wavelengths without power balance, those wavelengths are found and set (504). The wavelengths requiring power balance are then found and set (506). The TX and RX maximum power emphasis (MPE), a peak-to-peak value that defines the amount of allowed power variation due to power balancing at the TX and RX, are checked to ensure the estimated maximum and minimum powers of the wavelengths are acceptable (508). Finally the power adjustment is applied (510) and a new iteration will start over until the predefined performance tolerance satisfied.

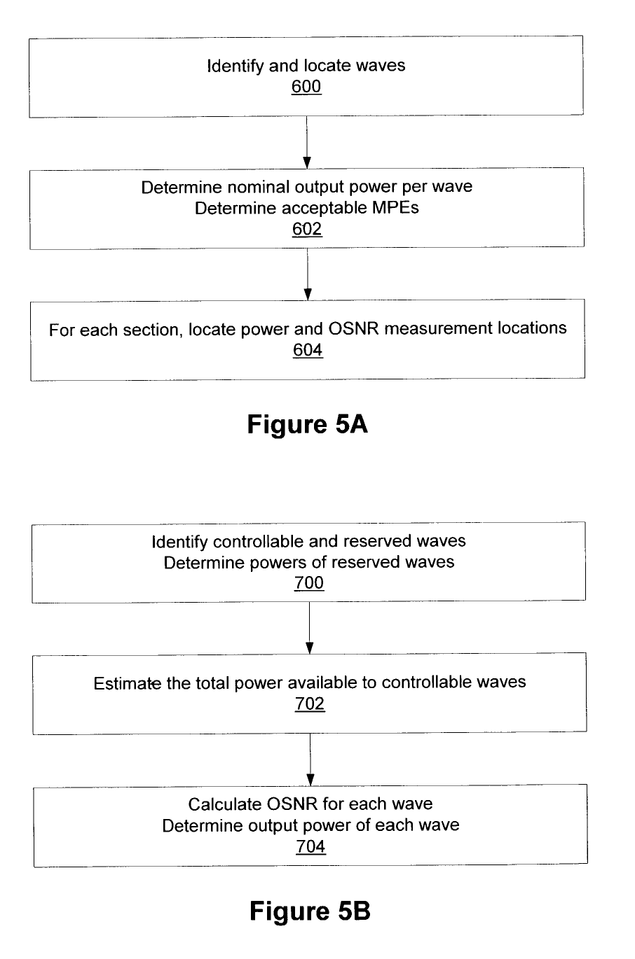

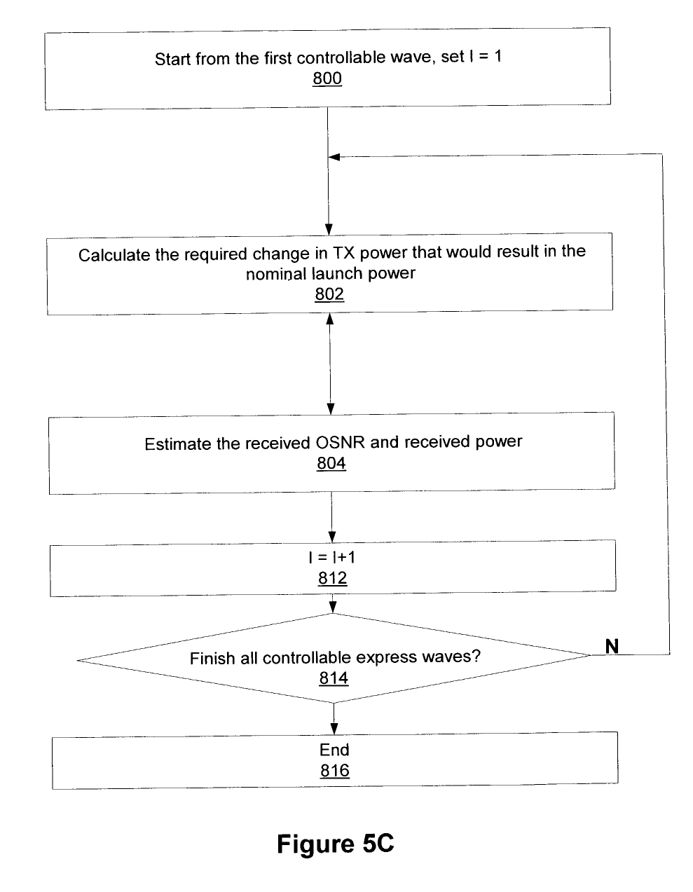

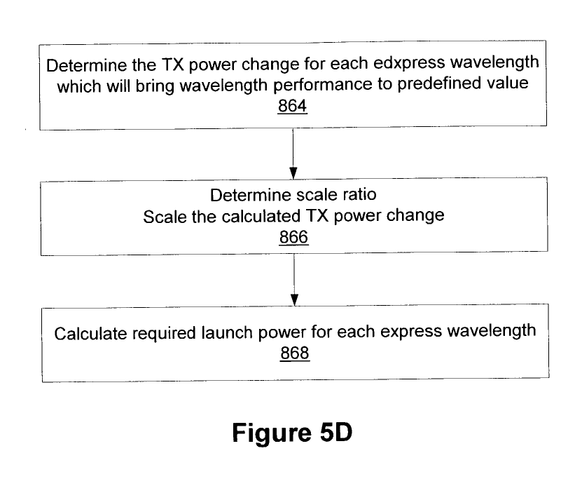

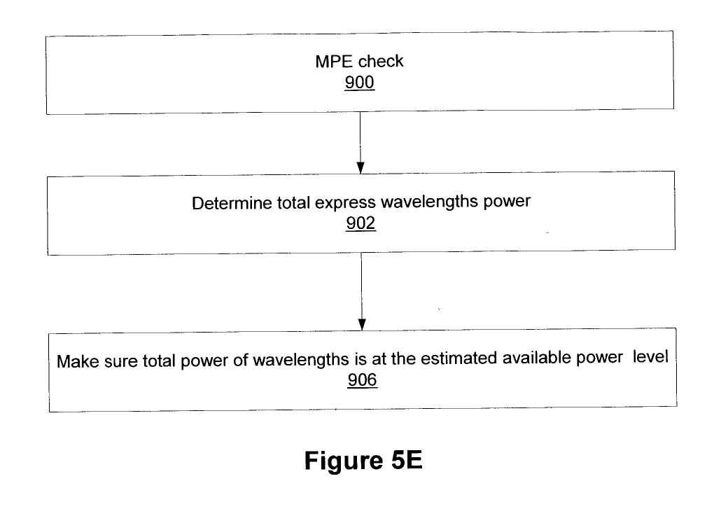

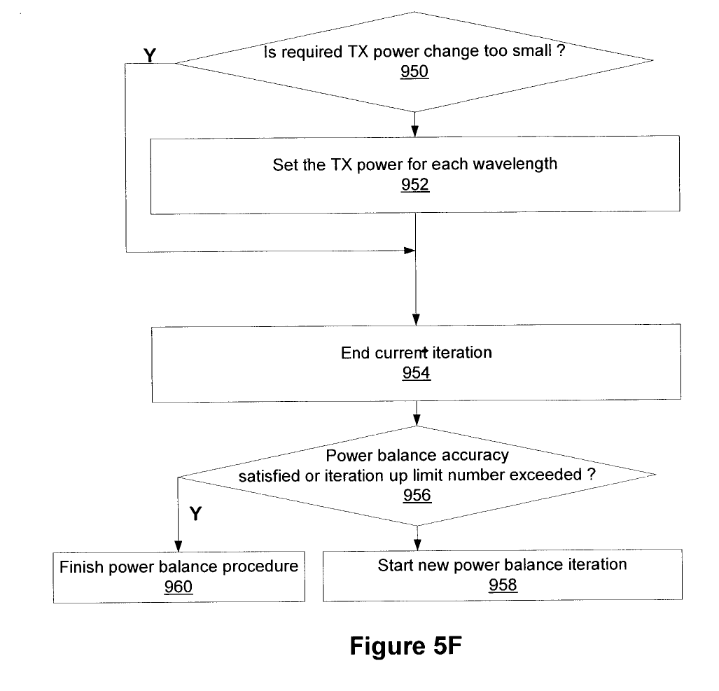

The operation of (500) is further illustrated in FIG. 5A. The wavelengths that are presently transmitting, added/dropped through the system in a particular band are identified and located (600). The nominal output power per wavelength out of the TX amplifier, P_{TX wave nom FAC} (dBm) is determined. This may be found on the FAC Turn-up MIB. Also determine the maximum power emphasis (MPE) that is acceptable at the TX and the RX as well (602). Locate the ports where all of the waves' (express and add/drop) optical powers and OSNRs are measured (604). This serves to locate the TX FAC at the beginning of the link, as well as the OPM connected to the TX FAC output monitor port. Also, the RX FAC is located at the end of the link, as well as the OPM connected to the RX FAC output monitor port.

The operation of step (502) is further illustrated in FIG. 5B. The controllable and reserved wavelengths, are identified and the actual wavelength power P_{TX wave i FAC} is obtained by measuring the TX optical spectra using the TX OPM. Further, the powers of controllable and reserved wavelengths, denoted as P_{TX contrl wave i FAC} (dBm) and P_{TX resvd wave i FAC} (dBm) are determined (700) and (702). The controllable wavelengths are separated into express and add/drop wavelengths, i.e. P_{TX contrl exp wave i FAC} (dBm) and P_{TX contrl a/d wave i FAC} (dBm). At each add/drop location, the TX power of all add/drop waves initiated at that location, P_{TX contrl a/d wave i FAC} is determined.

The RX optical spectra is measured using the RX OPM, again separating them into controllable and reserved wavelengths, P_{RX contrl wave i FAC} (dBm) and P_{RX resvd wave i FAC} (dBm), of which the controllable wavelengths are separated into express and add/drop wavelengths P_{RX contrl exp wave i FAC} (dBm) and P_{RX contrl a/d wave i FAC} (dBm) (and OSNR measurements O_{RX contrl exp wave i} (dBm) and O_{RX contrl a/d wave i} (dBm)). At each add/drop location, the RX power and OSNR of each add/drop waves that terminating at that location is measured, P_{RX contrl a/d wave i FAC} and O_{RX contrl a/d wave i} (704).

FIG. 5C illustrates with further details the operation of step (504) in FIG. 4. Starting from the first controllable express wavelength (800), for each controllable express wavelength i, the required change in TX power is calculated, ΔP_{TX contrl exp wave i,} that would result in the nominal TX launch power (802):

ΔP_{TX contrl exp wave i}=P_{TX wave nom FAC}−P_{TX contrl exp wave i FAC}

Estimate the received OSNR, O_{RX contrl exp wave i est}, and received power, P_{RX contrl exp wave i est} for that wavelength (804) as follows:

O_{RX contrl exp wave i est}=O_{RX contrl exp wave i}+ΔP_{TX contrl exp wave i}

P_{RX contrl exp wave i est}=P_{RX contrl exp wave i}+ΔP_{TX contrl exp wave I}

The average RX OSNR of the controllable express waves, for nominal TX power, O_{RX contrl exp wave ave est}, is then determined to be

O_{RX contrl exp wave ave est}=average{O_{RX contrl exp wave i est}}

The iteration number is updated (812). If the process is not finished yet, the process returns to (802) for the next controllable express wavelength (814); otherwise, the process ends (816).

FIG. 5D illustrates the detailed operation of step (506) in FIG. 4. For each express wavelength, an estimate of the required change in the TX power for optimum performance (which is prior defined, ΔP_{TX contrl exp wave i}) is determined by comparing the TX power spectrum, or the RX optical power and OSNR spectrum, to the desired one. Although the proposed method is applicable to system optimization relative to any customer defined performance criteria, only for illustration purposes, in the following, the desired performance is defined as flat receiver OSNR as in FIG. 5D. So ΔP_{TX contrl exp wave i} is determined by subtracting the value of the wavelength's present OSNR from the estimated average OSNR that can be achieved for nominal TX launch of each express wave (864):

ΔP_{TX contrl exp wave i}=O_{RX contrl exp wave ave est}−O_{RX contrl exp wave i}

A scaling variable for each wavelength, r₁, is used to determine the required output power change to the wavelength TX port output, for optimal performance. If this is the first iteration of the procedure, all the wavelength scaling variables are set to 1; otherwise, the ratio between the previous iterations change in RX OSNR, ΔO_{RX contrl exp wave i} to the change in TX port power for each wavelength is calculated, and set the respective wavelength's scaling variable is set to be this ratio: rᵢ, i.e.:

r₁=ΔO_{RX contrl exp wave i}/ΔP_{TX contrl exp wave i}

The final ΔP_{TX contrl exp wave i} will be adjusted by multiplying it by the obtained ratio (866):

ΔP_{TX control exp wave i}=ΔP_{TX contrl exp wave i}×r₁.

The required TX launch power for that wavelength can be calculated by adding ΔP_{TX contrl exp wave i} to the wavelength's port TX output power (868). If an MPE limit is reached (high or low), then set the TX launch power to that limit.

The optimum TX launch power for add/drop waves can then be determined using the adjacent controllable wavelength's power (the adjacent wave may be an controllable express wavelength or add/drop wavelength whose desired power has already been set), P_{TX contrl adj wave i FAC}, so that the added wave's power closely reflects the typical power of existing wavelengths. However, if the add/drop wave is more than, say 1 nm, away from the adjacent controllable wave, the desired power of ad/drop wave is set to the nominal TX launch power.

```
If|λ_{add wave i} − λ_{adj wave} | < 1 then
    ΔP_{TX contrl add/drop wave i est} = P_{TX contrl adj wave i FAC} −
    P_{TX contrl add/drop wave i FAC}
Else
    ΔP_{TX contrl add/drop wave i est} = P_{TX wave nom FAC} −
    P_{TX contrl add/drop wave i FAC}
```

At this point, all the estimated express wavelength powers for optimum performance have been determined. However, a check is made to ensure that the estimated maximum and minimum powers of the wavelengths will still be acceptable (508), which is further detailed in FIG. 5E. First, for each express wavelength i, if the TX FAC output power exceeds the TX MPE limit, a value for ΔP_{TX contrl exp wave i} that will result in the output power reaching the TX MPE limit is calculated, (900). This procedure can also be applied to the RX, if an MPE limit is applicable:

If ((P_{TX contrl exp wave i FAC}+ΔP_{TX contrl exp wave i est}) > (P_{TX nom wave FAC} +
0.5*MPE_{TX}))
Then
ΔP_{TX contrl exp wave i est} = P_{TX nom wave FAC} + 0.5*MPE_{TX} −
P_{TX contrl exp wave i FAC}
Else
If ((P_{TX contrl exp wave i FAC}+ΔP_{TX contrl exp wave i est}) < (P_{TX nom wave FAC} −
0.5*MPE_{TX}))
Then
ΔP_{TX contrl exp wave i est} = P_{TX nom wave FAC} − 0.5*MPE_{TX} −
P_{TX contrl exp wave i FAC}

The total estimated express power is calculated at the TX (and all other TX and RX locations, if appropriate), after the power change, for all wavelengths, including controllable express and add/drop, and reserved wavelengths step (902).

A check is made to ensure that total power does not exceed the available maximum power form the FAC (906).

The last step is to apply the determined power change to each wavelength as in (510) in FIG. 4. The details of this step are shown in FIG. 5F.

First, a determination is made as whether the required TX power changes for each controllable wavelength are too small (950). If the required TX power change for each wavelength is less than a predetermined value, such as 0.5 dB, current iteration (954); otherwise, the change to each TX wavelength is applied by setting the TX power for each wavelength as (952):

P_{TX contrl wave i PORT}=P_{TX contrl wave i PORT}+ΔP_{TX contrl wave i est}

The current power balance iteration is then completed (954). The power balance accuracy and iteration number are checked (956). If a predefined accuracy number is satisfied or an iteration up limit number exceeded (960), the power balance procedure is finished. Otherwise, start the next balancing iteration by going back to measure the TX optical spectra of all wavelengths and over for the next iteration is initiated of balancing (958).

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. A method for adding a plurality of wavelengths to an optical network with a plurality of nodes, comprising steps of:
selecting a node where said wavelengths will be added;
inserting said wavelengths into the system by:
determining a desired TX launch power for each of said wavelengths;
enabling each of said wavelengths;
determining a required power change for each of said wavelengths that will bring each of said wavelengths up to said desired TX launch power; and
applying said power changes to said wavelengths all together.

2. The method according to claim 1 wherein said step of inserting said wavelengths into the system further includes dividing said wavelengths into groups and applying said inserting step to each group individually.

3. The method according to claim 1 wherein said step of inserting said wavelengths into the system is implemented as a multiple iteration process.

4. The method according to claim 1, when said wavelengths are located in different transmission bands, said step of inserting applied to each band.

5. The method according to claim 1 wherein said desired TX launch power is defined as adjacent wavelength's power.

6. The method according to claim 1 wherein said desired TX launch power is defined as nominal TX launch power.

7. The method according to claim 1 wherein said step of enabling each of said wavelengths further includes setting an output power at an output of each wavelength port to a predetermined value.

8. The method according to claim 7 wherein said required power change for each of said wavelengths is determined by subtracting output power at the output of each of said wavelengths port from said desired TX launch power.

9. The method according to claim 1 wherein said step of applying said power changes to said wavelengths all together further includes altering the output power of wavelengths ports by the amount of said power changes.

10. The method according to claim 4 wherein said different transmission bands include C band, L band and S band.

11. The method according to claim 1 further comprising checking that said wavelengths to be added do not collide with existing wavelength traffic.

12. The method according to claim 1 further includes checking performance of said wavelengths after said wavelengths are inserted into the system.

13. The method according to claim 2 wherein said groups are based on an ITU grid wavelength standard.

14. The method according to claim 9 further comprising altering the output power of said wavelengths ports if the largest of said power changes is smaller than a predetermined value.

15. A method of power balancing for an optical network system with a plurality of wavelengths, comprising steps of:
determining controllable and reserved wavelengths;
for each of said controllable wavelength:
obtaining a TX power change that will bring performance of said controllable wavelength to a predetermined value; and
applying said TX power change to said controllable wavelength.

16. The method according to claim 15 further comprising determining total power available for controllable wavelength adjustment by ensuring reserved wavelength power is maintained.

17. The method according to claim 15 wherein said controllable wavelengths are further divided into express wavelengths add/drop wavelengths.

18. The method according to claim 15, wherein when the controllable wavelength is an add/drop wavelength, said TX power change is determined as adjacent wavelength's power.

19. The method according to claim 15, wherein when the controllable wavelength is an add/drop wavelength, said TX power change is determined as nominal TX launch power.

20. The method according to claim 15, wherein when the controllable wavelength is an express wavelength, wherein said TX power change is determined by comparing system performance to a predetermined value.

21. The method according to claim 20, wherein the system performance is TX power spectrum.

22. The method according to claim 20, wherein the system performance is RX power spectrum.

23. The method according to claim 20, wherein the system performance is RX OSNR spectrum.

24. The method according to claim 20, wherein the system performance is user-defined output power spectral shape.

25. The method according to claim 20, wherein the system performance is user-defined output OSNR spectral shape.

26. The method according to claim 15 wherein the step of determining the TX power change further comprises multiplying said TX power change by a scaling variable to obtain the final TX power change.
